(19) United States
(12) Patent Application Publication
(10) Pub. No.: US 2026/0100496 A1
(43) Pub. Date: Apr. 9, 2026

(54) STRUCTURE INCREASING SOLIDITY FOR SIDE-MOUNTED ANTENNA

(71) Applicants: Yun-Chan TSAI, Taipei City (TW); ONEWAVE TECHNOLOGY CO., LTD., Taipei City (TW)

(72) Inventors: Yun-Chan TSAI, Taipei City (TW); Shi-Yu CHIU, Taipei City (TW); Shi-Hong YANG, Taipei City (TW); Chin-Yun HSU, Taipei City (TW); Chien-Ku KUO, Taipei City (TW)

(73) Assignees: Yun-Chan TSAI, Taipei City (TW); ONEWAVE TECHNOLOGY CO., LTD., Taipei City (TW)

(21) Appl. No.: 19/088,819

(22) Filed: Mar. 24, 2025

(30) Foreign Application Priority Data
Oct. 7, 2024 (TW) 113210797

(51) Int. Cl. H01Q 1/00; H01Q 1/22; H01Q 5/307

(52) U.S. Cl. CPC H01Q 1/005; H01Q 1/2283; H01Q 5/307

(57) ABSTRACT

A structure includes an antenna structure and a mainboard. The antenna structure includes a circuit board, an electrode layer, and at least one half-hole electrode layer. The electrode layer and the half-hole electrode layer are arranged on the circuit board. A first solder pad and a second solder pad are arranged on the mainboard. A first electrode layer and a second electrode layer of the electrode layer, and the half-hole electrode layer arranged on the circuit board are electrically fixedly connected to the first solder pad and the second solder pad. When the antenna structure is soldered onto the mainboard, the soldering stability and solidity for the antenna structure is increased to prevent the antenna structure from shifting during production using surface mount technology. The solder pads are added to grasp the body of the antenna structure, thereby improving the problem of detaching when dropped.

### CROSS-REFERENCE TO RELATED APPLICATION

This application claims benefit of priority to Taiwanese Patent Application No. 113210797 filed Oct. 7, 2024, the entire contents of which are incorporated herein by reference.

### BACKGROUND OF THE DISCLOSURE

### Technical Field

The present disclosure relates to an antenna, and especially relates to a structure which increases a solidity for a side-mounted antenna.

### Description of Related Art

With the popularity of the Internet, people have become increasingly dependent on the Internet, and more and more Internet-connected apparatuses have been developed, such as Wi-Fi products, network communication products, Internet of Things, webcams, IP cameras, routers, or modems. Most of the antenna structures used in these apparatuses use etching technology to produce different radiation layer patterns on the copper foil on the circuit board for signal reception and transmission.

The antenna structure currently used in the above-mentioned apparatus is a side-mounted type and is soldered onto the mainboard of the electronic apparatus. When the antenna structure is soldered onto the mainboard, after the electrode layer on the circuit board of the antenna structure is soldered onto the solder pad of the mainboard, the antenna structure is side-mounted soldered onto one side of the circuit board.

During the production of the mainboard, the copper foil on the mainboard is made into square and large-area pads through etching technology. Since the solder pad is designed as a whole piece of square copper foil, when the antenna structure is soldered onto the mainboard using surface mount technology (SMT), if the antenna structure moves out of position, the whole square copper foil solder pad on the mainboard will not be able to firmly solder the antenna structure, causing the antenna structure to be unable to be firmly soldered onto the mainboard, causing the antenna structure to have a problem of detaching from the motherboard when dropped. This causes difficulty in production, and the finished product is prone to problems such as the poor contact or short circuit.

Therefore, the main problem solved by the present disclosure is how to improve the problem of the antenna structure shifting during the soldering process of the side-mounted antenna structure and the mainboard, so that the solder pads on the mainboard may firmly fix the antenna structure causing the antenna structure will not detach from the mainboard when dropped.

### SUMMARY OF THE INVENTION

Therefore, the main object of the present disclosure is to solve the traditional shortcomings. The present disclosure redesigns the solder pads on the mainboard. During the soldering process of the antenna structure and the mainboard, the soldering stability and solidity for the antenna structure may be increased to prevent the antenna structure from shifting during production using surface mount technology (SMT). The solder pads may also be added to firmly grasp or fix the body of the antenna structure, thereby improving the problem of the antenna structure detaching from the mainboard when dropped.

In order to achieve the object mentioned above, the present disclosure provides a structure increasing a solidity for a side-mounted antenna including: an antenna structure, a mainboard, a first solder pad, and a second solder pad. The antenna structure includes: a circuit board, an electrode layer, and at least one half-hole electrode layer. The circuit board is a square body including a front surface, a back surface, a top surface, a bottom surface, and two side surfaces. The electrode layer includes a first electrode layer and a second electrode layer. The first electrode layer and the second electrode layer are arranged on the front surface and the back surface of the circuit board, and are located at intersections of the bottom surface and the front surface and the back surface. The half-hole electrode layer is respectively arranged on the bottom surface of the circuit board, and is through the bottom surface, and is electrically connected to the first electrode layer and the second electrode layer arranged on the front surface and the back surface of the circuit board respectively. The first solder pad and the second solder pad are arranged on the mainboard. Moreover, the first electrode layer, the second electrode layer, and the half-hole electrode layer are electrically fixedly connected to the first solder pad and the second solder pad.

In an embodiment of the present disclosure, the first solder pad and the second solder pad are in an I-shape or a horizontally rotated H-shape.

In an embodiment of the present disclosure, the first solder pad and the second solder pad respectively include two horizontal lines and a vertical line. The two horizontal lines are parallel to each other. The vertical line is perpendicular to the two horizontal lines and is electrically connected between the two horizontal lines. The first electrode layer and the second electrode layer arranged on the front surface and the back surface of the circuit board are respectively electrically connected to the two horizontal lines of the first solder pad and the second solder pad. The half-hole electrode layer is electrically connected to the vertical line.

In an embodiment of the present disclosure, the antenna structure further includes another half-hole electrode layer respectively arranged on the bottom surface of the circuit board to form two of the half-hole electrode layers adjacent to each other.

In an embodiment of the present disclosure, the first solder pad and the second solder pad are in a shape of Roman numeral II.

In an embodiment of the present disclosure, the first solder pad and the second solder pad respectively include two horizontal lines and two vertical lines. The two horizontal lines are parallel to each other. The two vertical lines are perpendicular to the two horizontal lines and are electrically connected between the two horizontal lines. The first electrode layer and the second electrode layer arranged on the front surface and the back surface of the circuit board are respectively electrically connected to the two horizontal lines of the first solder pad and the second solder pad. The two of the half-hole electrode layers adjacent to each other are electrically connected to the two vertical lines.

In an embodiment of the present disclosure, the antenna structure further includes a side half-hole electrode layer respectively arranged on the bottom surface of the circuit board. The side half-hole electrode layer is located at a corner of the bottom surface and the side surface.

In an embodiment of the present disclosure, the first solder pad and the second solder pad respectively include two horizontal lines, a vertical line, and a side vertical line. The two horizontal lines are parallel to each other. The vertical line is perpendicular to the two horizontal lines and is electrically connected between the two horizontal lines. The side vertical line is connected to one side of the two vertical lines.

In an embodiment of the present disclosure, the first electrode layer and the second electrode layer arranged on the front surface and the back surface of the circuit board are respectively electrically connected to the two horizontal lines (which are parallel to each other) of the first solder pad and the second solder pad. The half-hole electrode layer and the side half-hole electrode layer are electrically connected to the vertical line and the side vertical line.

In an embodiment of the present disclosure, the antenna structure further includes radiation layers with different patterns and shapes arranged on the front surface and the back surface of the circuit board respectively. The radiation layers include a high-frequency radiation layer or a low-frequency radiation layer, or include the high-frequency radiation layer and the low-frequency radiation layer.

In an embodiment of the present disclosure, the structure further includes a first ground layer, a second ground layer, a first clearance area, a second clearance area, and a signal feed layer. The first ground layer and the first clearance area are arranged on a front face of the mainboard. The second ground layer and the second clearance area are arranged on a back face of the mainboard. The first ground layer and the second ground layer are symmetrical. The first clearance area and the second clearance area are symmetrical. The first solder pad and the second solder pad are arranged on the first clearance area which is arranged on the front face of the mainboard. The first solder pad and the second solder pad are electrically fixedly connected to the first electrode layer and the second electrode layer respectively. Moreover, the signal feed layer is arranged on the front face of the mainboard, and is coupled to the first ground layer, and is electrically connected to the first solder pad.

### BRIEF DESCRIPTION OF THE DRAWINGS

FIG. 1 shows an exploded schematic diagram of the antenna structure and the mainboard of the first embodiment of the present disclosure.

FIG. 2 shows an exploded schematic diagram of the antenna structure and the mainboard from another angle of view of FIG. 1.

FIG. 3 shows a three-dimensional assembly schematic diagram of FIG. 1.

FIG. 4 shows a three-dimensional assembly schematic diagram of FIG. 2.

FIG. 5 shows an exploded schematic diagram of the antenna structure and the mainboard of the second embodiment of the present disclosure.

FIG. 6 shows an exploded schematic diagram of the antenna structure and the mainboard from another angle of view of FIG. 5.

FIG. 7 shows an exploded schematic diagram of the antenna structure and the mainboard of the third embodiment of the present disclosure.

FIG. 8 shows an exploded schematic diagram of the antenna structure and the mainboard from another angle of view of FIG. 7.

### DETAILED DESCRIPTION

The technical content and the detailed description of the present disclosure are now explained with the drawings as follows.

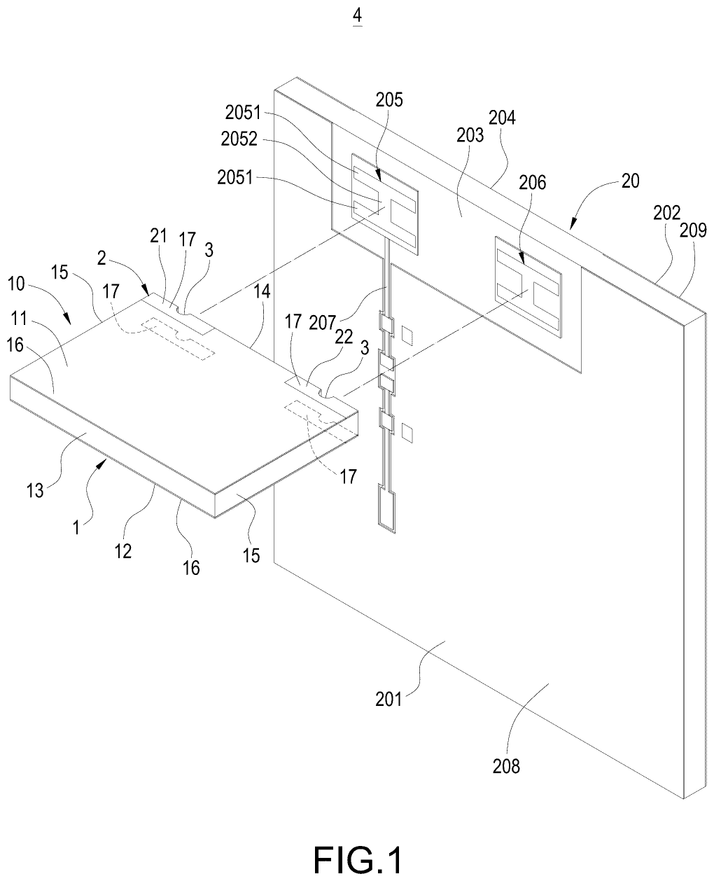

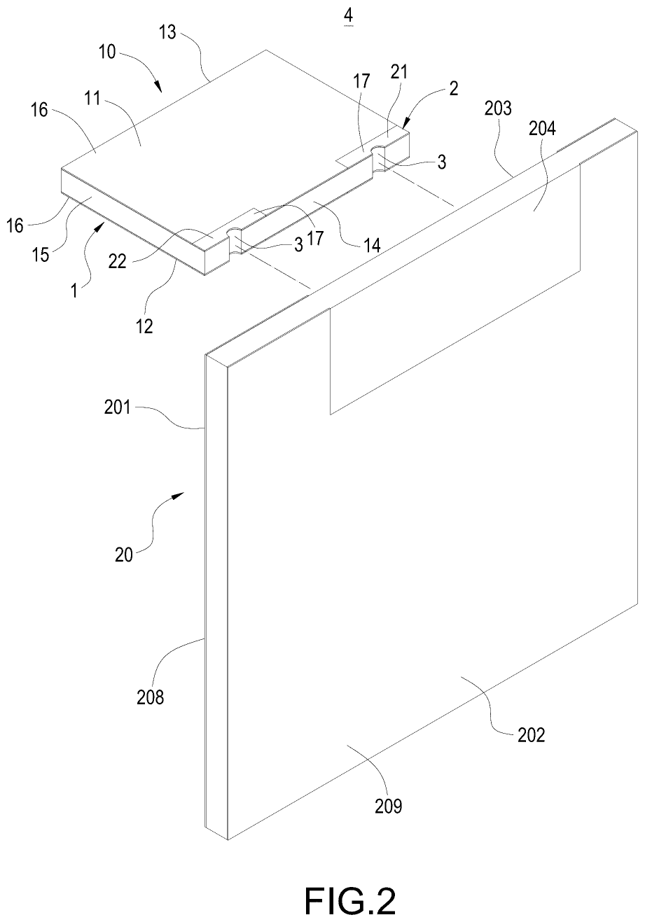

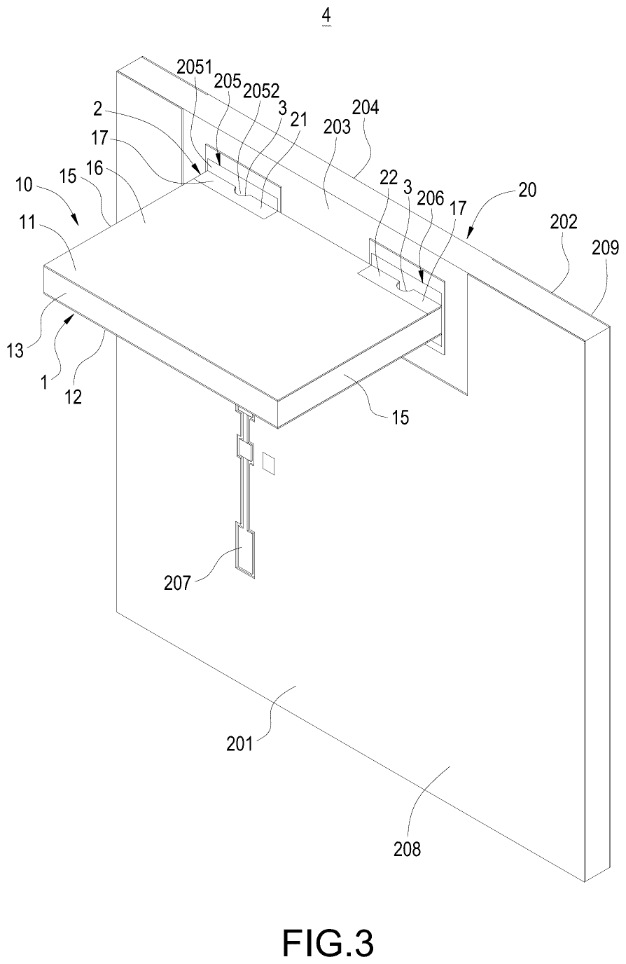

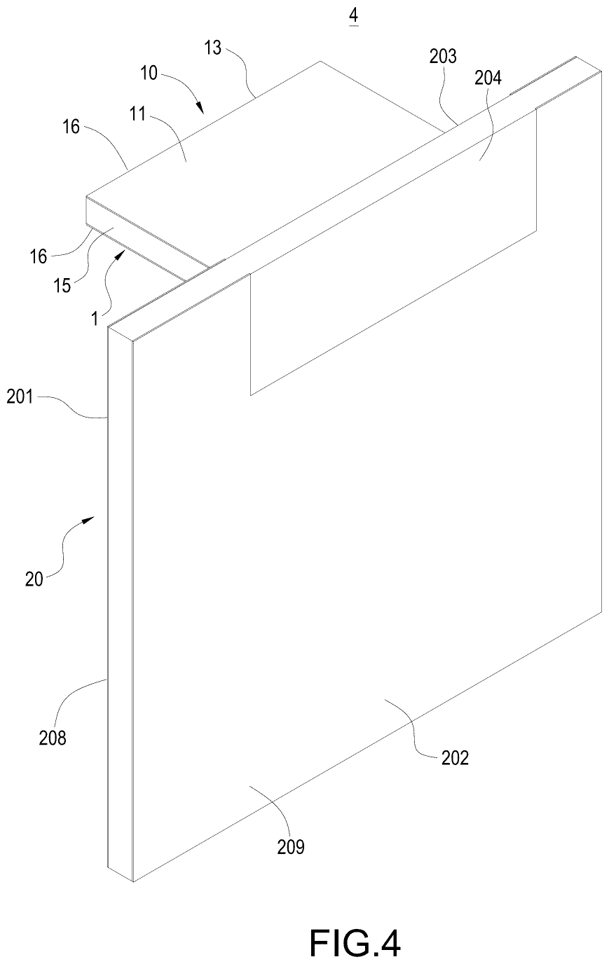

FIG. 1 shows an exploded schematic diagram of the antenna structure and the mainboard of the first embodiment of the present disclosure. FIG. 2 shows an exploded schematic diagram of the antenna structure and the mainboard from another angle of view of FIG. 1. FIG. 3 shows a three-dimensional assembly schematic diagram of FIG. 1. FIG. 4 shows a three-dimensional assembly schematic diagram of FIG. 2. As shown in FIG. 1 to FIG. 4, a structure 4 increasing a solidity for a side-mounted antenna of the present disclosure includes an antenna structure 10, a mainboard 20, a first solder pad 205, a second solder pad 206, a first ground layer 201, a second ground layer 202, a first clearance area 203, a second clearance area 204, and a signal feed layer 207. The antenna structure 10 includes a circuit board 1, an electrode layer 2, half-hole electrode layers 3, and radiation layers 16.

The circuit board 1 is a square body including a front surface 11, a back surface 12, a top surface 13, a bottom surface 14, and two side surfaces 15. The radiation layers 16 with different patterns and shapes are arranged on the front surface 11 and the back surface 12 respectively. The radiation layers 16 include a high-frequency radiation layer or a low-frequency radiation layer, or include the high-frequency radiation layer and the low-frequency radiation layer, which are used for receiving signals and transmitting signals. In FIG. 1 to FIG. 4, the circuit board 1 is a printed circuit board.

The electrode layer 2 is arranged on the front surface 11 and the back surface 12 of the circuit board 1, and is located at intersections 17 of the bottom surface 14 and the front surface 11 and the back surface 12. The electrode layer 2 is electrically connected to the radiation layers 16. The electrode layer 2 includes: a first electrode layer 21 and a second electrode layer 22. The first electrode layer 21 and the second electrode layer 22 are electrically fixedly connected to the first solder pad 205 and the second solder pad 206 which are arranged on the mainboard 20.

The half-hole electrode layers 3 are arranged on the bottom surface 14 of the circuit board 1, and are through the bottom surface 14 of the circuit board 1, so that the half-hole electrode layers 3 are electrically connected to the first electrode layer 21 and the second electrode layer 22 which are arranged on the front surface 11 and the back surface 12 of the circuit board 1 respectively. In FIG. 1 to FIG. 4, the half-hole electrode layers 3 are semicircular, semielliptical, or polygonal.

It is worth mentioning that the half-hole electrode layers 3 are designed to reduce the manufacturing cost of the antenna structure 10, and allows the antenna structure 10 to be electrically fixedly connected to the first solder pad 205 and the second solder pad 206 which are arranged on the mainboard 20 without destroying the original structure of the mainboard 20.

In the present disclosure, when the antenna structure 10 is used with the motherboard 20 of an electronic apparatus, the first ground layer 201 and the first clearance area 203 are arranged on a front face 208 of the mainboard 20. The second ground layer 202 and the second clearance area 204 are arranged on a back face 209 of the mainboard 20. The first ground layer 201 and the second ground layer 202 are symmetrical (for example, identical). The first clearance area 203 and the second clearance area 204 are symmetrical (for example, identical). The first solder pad 205 and the second solder pad 206 are arranged on the first clearance area 203 which is arranged on the front face 208 of the mainboard 20. Moreover, the signal feed layer 207 is arranged on the front face 208 of the mainboard 20, and is coupled to the first ground layer 201, and is electrically connected to the first solder pad 205. Moreover, the second solder pad 206 may be electrically connected to the first ground layer 201 through a matching component (not shown in the drawings) to adjust antenna frequency characteristics.

It is worth mentioning that both the first solder pad 205 and the second solder pad 206 of the present disclosure are in an I-shape or a horizontally rotated H-shape. The first solder pad 205 (the second solder pad 206) respectively includes two horizontal lines 2051 and a vertical line 2052. The two horizontal lines 2051 are parallel to each other. The vertical line 2052 is perpendicular to the two horizontal lines 2051 and is electrically connected between the two horizontal lines 2051. When the antenna structure 10 is electrically connected to the first solder pad 205 and the second solder pad 206 which are arranged on the mainboard 20, the first electrode layer 21 and the second electrode layer 22 which are arranged on the front surface 11 and the back surface 12 of the circuit board 1 are respectively electrically connected to the two horizontal lines 2051 (which are parallel to each other) of the first solder pad 205 and the second solder pad 206. The two half-hole electrode layers 3 are electrically connected to the vertical line 2052.

Through the design of the first solder pad 205 and the second solder pad 206 which are arranged on the mainboard 20 mentioned above, the soldering stability and solidity for the antenna structure 10 may be increased to prevent the antenna structure 10 from shifting during production using surface mount technology (SMT). The first solder pad 205 and the second solder pad 206 may also be added to firmly grasp or fix the body of the antenna structure 10, thereby improving the problem of the antenna structure 10 detaching from the mainboard 20 when dropped.

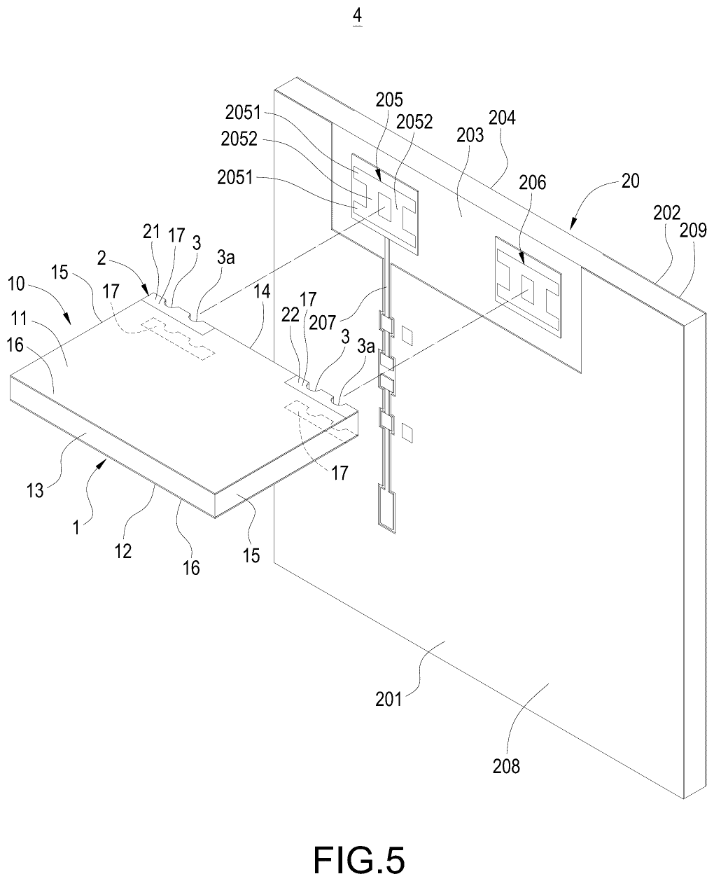

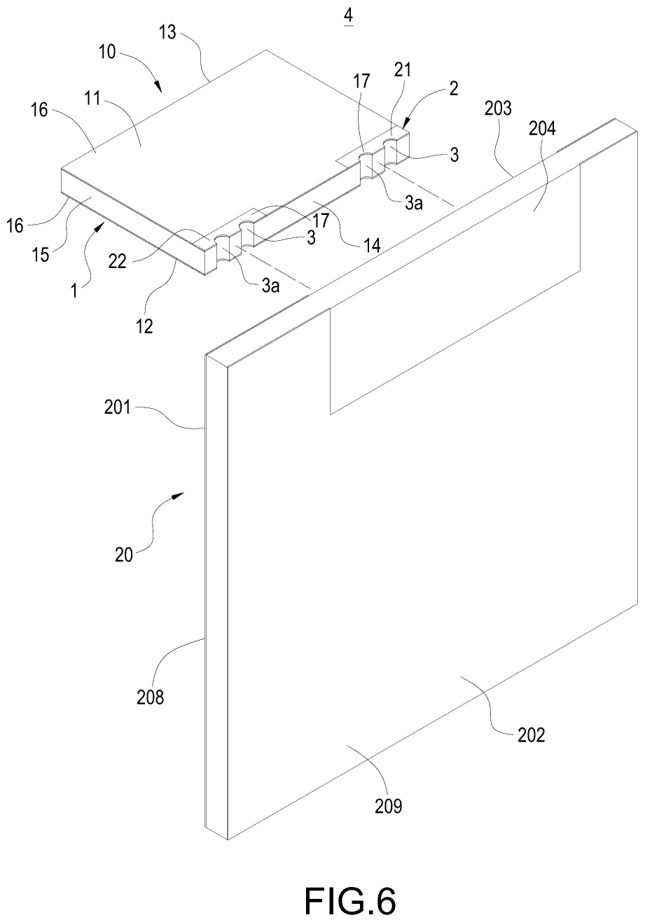

FIG. 5 shows an exploded schematic diagram of the antenna structure and the mainboard of the second embodiment of the present disclosure. FIG. 6 shows an exploded schematic diagram of the antenna structure and the mainboard from another angle of view of FIG. 5. Please refer to FIG. 1 to FIG. 4 at the same time. As shown in FIG. 1 to FIG. 6, the antenna structure 10 and the mainboard 20 of the second embodiment are substantially the same as those of the first embodiment. The difference is that the antenna structure 10 further includes another half-hole electrode layer 3a respectively arranged on the bottom surface 14 of the circuit board 1 of the antenna structure 10 to form two of the half-hole electrode layers 3 and 3a adjacent to each other. The two half-hole electrode layers 3 and 3a are electrically connected to the first electrode layer 21 and the second electrode layer 22 which are arranged on the front surface 11 and the back surface 12 of the circuit board 1 respectively.

Relatively, the first solder pad 205 (the second solder pad 206) arranged on the mainboard 20 is in a shape of Roman numeral II. The first solder pad 205 (the second solder pad 206) respectively includes two horizontal lines 2051 and two vertical lines 2052. The two horizontal lines 2051 are parallel to each other. The two vertical lines 2052 are perpendicular to the two horizontal lines 2051 and are electrically connected between the two horizontal lines 2051. When the antenna structure 10 is electrically connected to the first solder pad 205 and the second solder pad 206 which are arranged on the mainboard 20, the first electrode layer 21 and the second electrode layer 22 which are arranged on the front surface 11 and the back surface 12 of the circuit board 1 are respectively electrically connected to the two horizontal lines 2051 (which are parallel to each other) of the first solder pad 205 and the second solder pad 206. The two half-hole electrode layers 3 and 3a are electrically connected to the two vertical lines 2052.

Similarly, through the design of the first solder pad 205 and the second solder pad 206 which are arranged on the mainboard 20, the soldering stability and solidity for the antenna structure 10 may be increased to prevent the antenna structure 10 from shifting during production using surface mount technology (SMT). The first solder pad 205 and the second solder pad 206 may also be added to firmly grasp or fix the body of the antenna structure 10, thereby improving the problem of the antenna structure 10 detaching from the mainboard 20 when dropped.

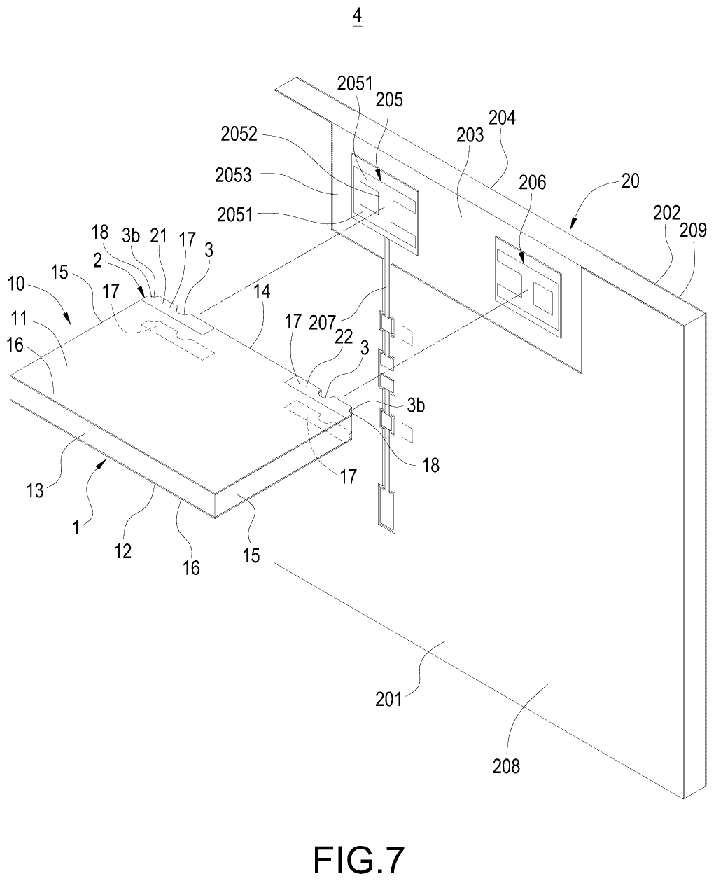

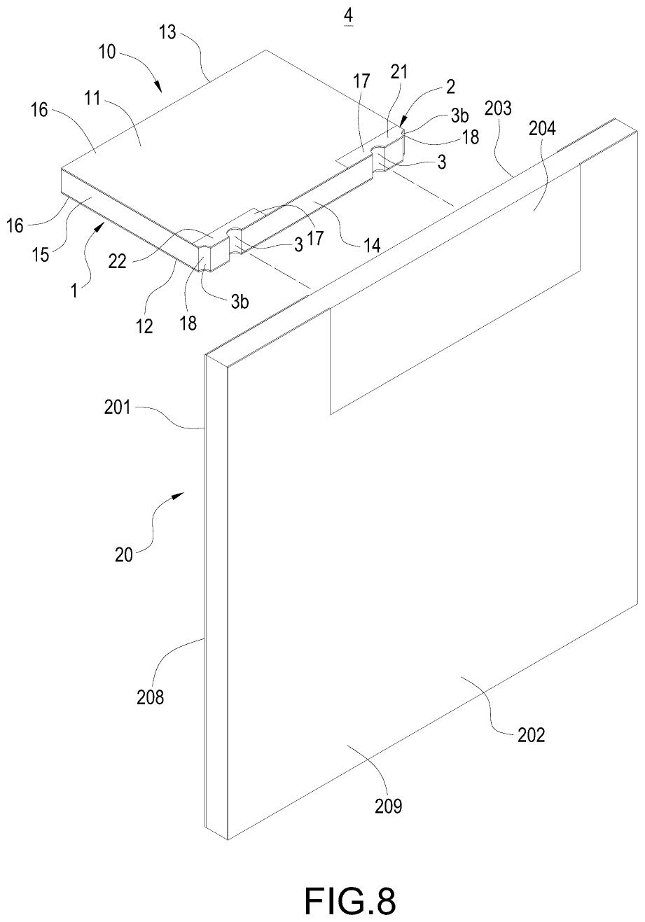

FIG. 7 shows an exploded schematic diagram of the antenna structure and the mainboard of the third embodiment of the present disclosure. FIG. 8 shows an exploded schematic diagram of the antenna structure and the mainboard from another angle of view of FIG. 7. Please refer to FIG. 1 to FIG. 6 at the same time. As shown in FIG. 1 to FIG. 8, the antenna structure 10 and the mainboard 20 of the third embodiment are substantially the same as those of the first embodiment and the second embodiment. The difference is that the antenna structure 10 further includes a side half-hole electrode layer 3b respectively arranged on the bottom surface 14 of the circuit board 1 of the antenna structure 10. The side half-hole electrode layer 3b is located at a corner 18 of the bottom surface 14 and the side surface 15. The half-hole electrode layers 3 and the side half-hole electrode layer 3b are electrically connected to the first electrode layer 21 and the second electrode layer 22 which are arranged on the front surface 11 and the back surface 12 of the circuit board 1 respectively.

At the same time, the first solder pad 205 (the second solder pad 206) arranged on the mainboard 20 respectively includes two horizontal lines 2051, a vertical line 2052, and a side vertical line 2053. The two horizontal lines 2051 are parallel to each other. The vertical line 2051 is perpendicular to the two horizontal lines 2051 and is electrically connected between the two horizontal lines 2051. The side vertical line 2053 is connected to one side of the two vertical lines 2051. When the antenna structure 10 is electrically connected to the first solder pad 205 and the second solder pad 206 which are arranged on the mainboard 20, the first electrode layer 21 and the second electrode layer 22 which are arranged on the front surface 11 and the back surface 12 of the circuit board 1 are respectively electrically connected to the two horizontal lines 2051 (which are parallel to each other) of the first solder pad 205 and the second solder pad 206. The half-hole electrode layer 3 and the side half-hole electrode layer 3b are electrically connected to the vertical line 2052 and the side vertical line 2053.

Similarly, through the design of the first solder pad 205 and the second solder pad 206 which are arranged on the mainboard 20, the soldering stability and solidity for the antenna structure 10 may be increased to prevent the antenna structure 10 from shifting during production using surface mount technology (SMT). The first solder pad 205 and the second solder pad 206 may also be added to firmly grasp or fix the body of the antenna structure 10, thereby improving the problem of the antenna structure 10 detaching from the mainboard 20 when dropped.

However, the above descriptions are only preferred embodiments of the present disclosure and are not intended to limit the scope of the patent protection of the present disclosure. Therefore, any equivalent changes made by using the contents of the specifications or the drawings of the present disclosure are equally included in the scope of the patent protection of the present disclosure and are hereby stated.

What is claimed is:

1. A structure increasing a solidity for a side-mounted antenna comprising: an antenna structure, a mainboard, a first solder pad, and a second solder pad, wherein the antenna structure comprises:
a circuit board being a square body comprising a front surface, a back surface, a top surface, a bottom surface, and two side surfaces;
an electrode layer comprising a first electrode layer and a second electrode layer, wherein the first electrode layer and the second electrode layer are arranged on the front surface and the back surface of the circuit board, wherein the first electrode layer and the second electrode layer are located at intersections of the bottom surface and the front surface and the back surface; and
at least one half-hole electrode layer respectively arranged on the bottom surface of the circuit board, and being through the bottom surface, and electrically connected to the first electrode layer and the second electrode layer arranged on the front surface and the back surface of the circuit board respectively,
wherein the first solder pad and the second solder pad are arranged on the mainboard,
wherein the first electrode layer, the second electrode layer, and the half-hole electrode layer are electrically fixedly connected to the first solder pad and the second solder pad.

2. The structure of the claim 1, wherein the first solder pad and the second solder pad are in an I-shape or a horizontally rotated H-shape.

3. The structure of the claim 2, wherein the first solder pad and the second solder pad respectively include two horizontal lines and a vertical line; the two horizontal lines are parallel to each other; the vertical line is perpendicular to the two horizontal lines and is electrically connected between the two horizontal lines; the first electrode layer and the second electrode layer arranged on the front surface and the back surface of the circuit board are respectively electrically connected to the two horizontal lines of the first solder pad and the second solder pad; the half-hole electrode layer is electrically connected to the vertical line.

4. The structure of the claim 1, wherein the antenna structure further comprises another half-hole electrode layer respectively arranged on the bottom surface of the circuit board to form two of the half-hole electrode layers adjacent to each other.

5. The structure of the claim 4, wherein the first solder pad and the second solder pad are in a shape of Roman numeral II.

6. The structure of the claim 5, wherein the first solder pad and the second solder pad respectively include two horizontal lines and two vertical lines; the two horizontal lines are parallel to each other; the two vertical lines are perpendicular to the two horizontal lines and are electrically connected between the two horizontal lines; the first electrode layer and the second electrode layer arranged on the front surface and the back surface of the circuit board are respectively electrically connected to the two horizontal lines of the first solder pad and the second solder pad; the two of the half-hole electrode layers adjacent to each other are electrically connected to the two vertical lines.

7. The structure of the claim 1, wherein the antenna structure further comprises a side half-hole electrode layer respectively arranged on the bottom surface of the circuit board; the side half-hole electrode layer is located at a corner of the bottom surface and the side surface.

8. The structure of the claim 7, wherein the first solder pad and the second solder pad respectively include two horizontal lines, a vertical line, and a side vertical line; the two horizontal lines are parallel to each other; the vertical line is perpendicular to the two horizontal lines and is electrically connected between the two horizontal lines; the side vertical line is connected to one side of the two vertical lines.

9. The structure of the claim 8, wherein the first electrode layer and the second electrode layer arranged on the front surface and the back surface of the circuit board are respectively electrically connected to the two horizontal lines of the first solder pad and the second solder pad; the half-hole electrode layer and the side half-hole electrode layer are electrically connected to the vertical line and the side vertical line.

10. The structure of the claim 1, wherein the antenna structure further comprises radiation layers with different patterns and shapes arranged on the front surface and the back surface of the circuit board respectively; the radiation layers comprise a high-frequency radiation layer or a low-frequency radiation layer, or comprise the high-frequency radiation layer and the low-frequency radiation layer.

11. The structure of the claim 1, further comprising a first ground layer, a second ground layer, a first clearance area, a second clearance area, and a signal feed layer, wherein the first ground layer and the first clearance area are arranged on a front face of the mainboard; the second ground layer and the second clearance area are arranged on a back face of the mainboard; the first ground layer and the second ground layer are symmetrical; the first clearance area and the second clearance area are symmetrical; the first solder pad and the second solder pad are arranged on the first clearance area arranged on the front face of the mainboard; the first solder pad and the second solder pad are electrically fixedly connected to the first electrode layer and the second electrode layer respectively; the signal feed layer is arranged on the front face of the mainboard, and is coupled to the first ground layer, and is electrically connected to the first solder pad.
